(19) United States
(12) Patent Application Publication
(10) Pub. No.: US 2024/0109165 A1
(43) Pub. Date: Apr. 4, 2024

(54) COMPOSITE SUBSTRATE CUTTING APPARATUS AND METHOD OF CUTTING COMPOSITE SUBSTRATE

(71) Applicant: CORNING INCORPORATED, Corning, NY (US)

(72) Inventors: Woo Jin Lee, Cheonan (KR); Jongsup Yeom, Asan-si (KR)

(21) Appl. No.: 18/268,010

(22) PCT Filed: Dec. 7, 2021
(86) PCT No.: PCT/US2021/062115

§ 371 Date: Jun. 16, 2023

(30) Foreign Application Priority Data
Dec. 22, 2020 (KR) 10-2020-0181347

(51) Int. Cl. B24C 1/04

(52) U.S. Cl. CPC B24C 1/045

(57) ABSTRACT

An apparatus for cutting a composite substrate includes a support configured to support a composite substrate including a first layer and a second layer that includes a material different from the first layer, a water jet nozzle configured to eject high-pressure water to cut the composite substrate and move along an upper surface of the support, a jet pressure controller configured to control a pressure of the high-pressure water ejected from the water jet nozzle, and a motion controller configured to control a movement of the water jet nozzle.

### CROSS-REFERENCE TO RELATED APPLICATION

This application is based on and claims priority under 35 U.S.C. § 119 to Korean Patent Application No. 10-2020-0181347, filed on Dec. 22, 2020, in the Korean Intellectual Property Office, the disclosure of which is incorporated by reference herein in its entirety.

### BACKGROUND

The disclosure relates to a composite substrate cutting apparatus and a method of cutting a composite substrate, and more particularly, to an apparatus for and method of cutting a composite substrate without damaging a specific layer.

Substrates in which heterogeneous materials are bonded have been used for various purposes. In particular, by forming a printing layer of a picture or a photo on a metal substrate and then a glass layer thereon, panels with excellent appearance may be used as interior and exterior materials for buildings, electronic products, and works of art. Improvements have been required in a method of cutting panels into desired shapes and sizes while maintaining a beautiful appearance.

### SUMMARY

The disclosure provides an apparatus for cutting a composite substrate without damaging a specific layer.

The disclosure provides a method of cutting a composite substrate without damaging a specific layer.

Additional aspects will be set forth in part in the description which follows and, in part, will be apparent from the description, or may be learned by practice of the presented embodiments of the disclosure.

According to an aspect of the disclosure, an apparatus for cutting a composite substrate includes a support configured to support a composite substrate that includes a first layer and a second layer including a material different from the first layer, a water jet nozzle configured to eject high-pressure water to cut the composite substrate and move along an upper surface of the support, a jet pressure controller configured to control a pressure of the high-pressure water ejected from the water jet nozzle, and a motion controller configured to control a movement of the water jet nozzle, wherein the jet pressure controller is configured to perform a first piercing operation of ejecting the high-pressure water at a relatively low pressure to form a hole in the first layer, and a second piercing operation of ejecting the high-pressure water at a relatively high pressure to form a hole in the second layer through the hole formed in the first layer after the first piercing operation.

In some embodiments, the motion controller may be configured to move the water jet nozzle along a cutting path after the hole is formed in the second layer, and the jet pressure controller may be further configured to maintain an ejection pressure of the high-pressure water at a cutting pressure of about 45,000 psia to about 90,000 psia when the water jet nozzle moves along the cutting path.

In some embodiments, when the water jet nozzle performs cutting across the cutting path along which the composite substrate was already cut, the jet pressure controller may be configured to limit the cutting pressure to be between about 45,000 psia and about 55,000 psia.

In some embodiments, the first piercing operation may be an operation in which, for a first duration, the pressure of the high-pressure water is maintained at a first pressure of about 5,000 psia to about 15,000 psia, and the second piercing operation may be an operation in which, for a second duration, the pressure of the high-pressure water is maintained at a second pressure of about 45,000 psia to about 90,000 psia. In the first piercing operation, a change in the first pressure may be maintained within a range of ±500 psia for a time of 1.5 seconds or more and 5 seconds or less, and in the second piercing operation, a change in the second pressure may be maintained within a range of ±2000 psia for a time of 1 second or more and 5 seconds or less.

In some embodiments, the first layer may be a glass layer having a thickness of about 0.2 mm to about 1.4 mm. In some embodiments, the second layer may include a first metal layer having a thickness of about 0.2 mm to about 0.8 mm, a core substrate having a thickness of about 1 mm to about 10 mm, and a second metal layer having a thickness of about 0.2 mm to about 0.8 mm.

In some embodiments, the jet pressure controller may be configured to control the first piercing operation and the second piercing operation to be successively performed and substantially uniformly increase an ejection pressure of the high-pressure water to reach a cutting pressure when the second piercing operation is finished.

In some embodiments, the motion controller may be configured to control a position of the water jet nozzle such that a distance between a tip of the water jet nozzle and the composite substrate is about 3 mm to about 20 mm.

In some embodiments, the apparatus may further include a pressurizing plate configured to apply a pressure to a part of the composite substrate to flatten the composite substrate, the pressurizing plate being provided to face the support with the composite substrate therebetween.

According to another aspect of the disclosure, a method of cutting a composite substrate, the method including providing the composite substrate on a support, the composite substrate including a first layer and a second layer including a material different from the first layer, a first piercing operation of ejecting high-pressure water at a relatively low pressure through a water jet nozzle to form a hole in the first layer, a second piercing operation of ejecting the high-pressure water at a relatively high pressure through the water jet nozzle to form a hole in the second layer through the hole formed in the first layer, after the first piercing operation, and a cutting operation of moving the water jet nozzle along a cutting path while the water jet nozzle ejects the high-pressure water through the water jet nozzle at a cutting pressure, after the second piercing operation.

In some embodiments, the first piercing operation may be an operation in which, for a first duration, the pressure of the high-pressure water is maintained at a first pressure of about 5,000 psia to about 15,000 psia, and the second piercing operation may be an operation in which, for a second duration, the pressure of the high-pressure water is maintained at a second pressure of about 45,000 psia to about 90,000 psia. The second pressure may be substantially the same as the cutting pressure.

In some embodiments, the first piercing operation and the second piercing operation may be successively performed, and an ejection pressure of the high-pressure water may be substantially uniformly increased from a start of the first piercing operation to reach the cutting pressure at a completion of the second piercing operation.

In some embodiments, the cutting pressure may be between about 45,000 psia and about 90,000 psia. In the cutting operation, when the water jet nozzle performs cutting across a cutting path along which the composite substrate was already cut, the cutting pressure may be limited to be between about 45,000 psia and about 55,000 psia.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a composite substrate cutting apparatus according to an embodiment of the disclosure;

FIG. 2 is a schematic perspective view illustrating cutting of a composite substrate by using a composite substrate cutting apparatus, according to an embodiment of the disclosure;

FIG. 3 is a schematic cross-sectional view of the composite substrate cut by the composite substrate cutting apparatus;

FIG. 4 is an image of a first layer damaged when the first layer and a second layer are pierced at a time by high-pressure water;

FIG. 5 is a flowchart of a method of cutting a composite substrate according to an embodiment of the disclosure;

FIG. 6 is a pressure profile of high-pressure water over time when the high-pressure water is ejected when the method of FIG. 5 is performed;

FIG. 7 is an image of holes formed according to the pressure profile of FIG. 6;

FIG. 8 is a pressure profile of high-pressure water over time when the high-pressure water is ejected in a method of cutting a composite substrate according to another embodiment of the disclosure;

FIG. 9 is an image of holes formed according to the pressure profile of FIG. 8;

FIGS. 10A and 10B are pressure profiles of high-pressure water over time when the high-pressure water is ejected in methods of cutting a composite substrate according to embodiments of the disclosure;

FIG. 11 is a schematic view of a relative arrangement of a composite substrate to be cut and a water jet nozzle; and

FIG. 12 is a schematic view of a method of cutting a composite substrate according to an embodiment of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompanying drawings, in which embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those of ordinary skill in the art. Any one embodiment may be combined to another embodiment unless contradictory to each other. Also, one constituent element of any one embodiment may be combined to another embodiment unless they contradict each other.

Like reference numbers denote like elements. Furthermore, various components and regions in the drawings are schematically drawn. Accordingly, the concept of the disclosure is not limited by relative sizes or intervals illustrated in the accompanying drawings.

While such terms as “first,” “second,” etc., may be used to describe various components, such components must not be limited to the above terms. The above terms are used only to distinguish one component from another. For example, without departing from the right scope of the disclosure, a first constituent element may be referred to as a second constituent element, and vice versa.

Terms used in the specification are used for explaining a specific embodiment, not for limiting the disclosure. Thus, an expression used in a singular form in the specification also includes the expression in its plural form unless clearly specified otherwise in context. Also, terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

Unless defined otherwise, all terms used herein including technical or scientific terms have the same meanings as those generally understood by those of ordinary skill in the art to which the disclosure may pertain. The terms as those defined in generally used dictionaries are construed to have meanings matching that in the context of related technology and, unless clearly defined otherwise, are not construed to be ideally or excessively formal.

When a certain embodiment may be implemented differently, a specific process order may be performed differently from the described order. For example, two consecutively described processes may be performed substantially at the same time or performed in an order opposite to the described order.

In the accompanying drawings, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing. As used herein, the term “and/or” includes any and all combinations of one or more of the associated listed items. Furthermore, the term “substrate” used herein may mean a substrate by itself, or a stack structure including a substrate and a certain layer or film formed on a surface thereof. Furthermore, the term “surface of a substrate” used herein may mean an exposed surface of a substrate by itself, or an external surface such as a certain layer or film formed on the substrate.

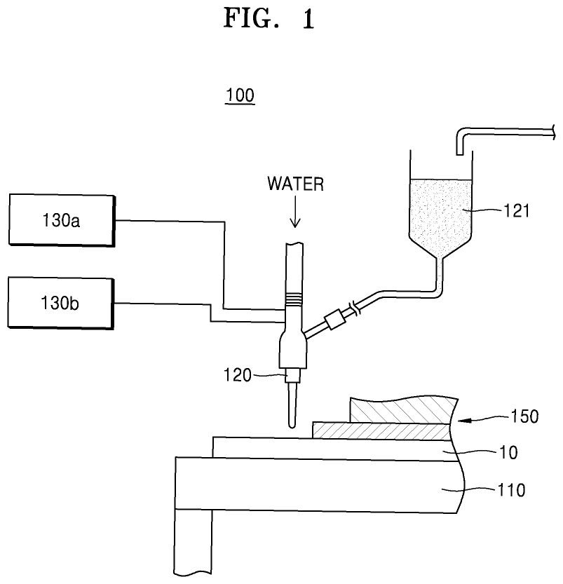

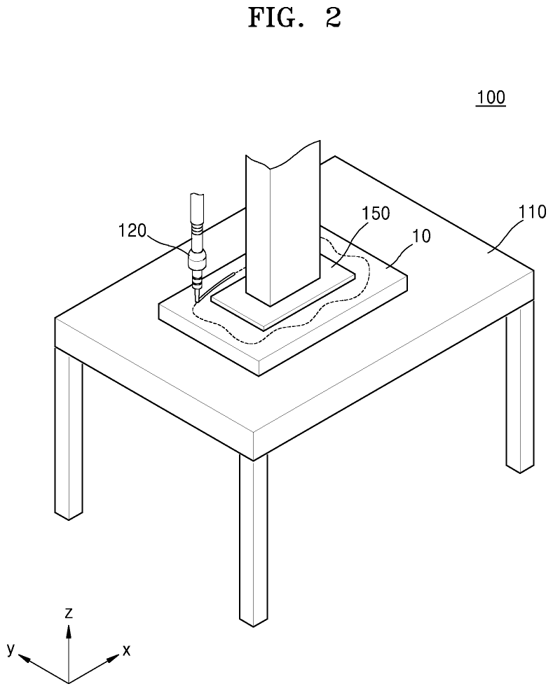

FIG. 1 is a schematic view of a composite substrate cutting apparatus 100 according to an embodiment of the disclosure. FIG. 2 is a perspective view of cutting a composite substrate 10 by using the composite substrate cutting apparatus 100, according to an embodiment of the disclosure.

Referring to FIGS. 1 and 2, the composite substrate cutting apparatus 100 may include a support 110 supporting the composite substrate 10, a water jet nozzle 120 configured to eject high-pressure water to cut the composite substrate 10, a jet pressure controller 130a configured to control a pressure of high-pressure water ejected through the water jet nozzle 120, and a motion controller 130b configured to control a movement of the water jet nozzle 120.

The support 110 may have an upper surface parallel to an x-y plane, and the composite substrate 10 may be placed on the upper surface. In some embodiments, the support 110 may further include a clamp for fixing the composite substrate 10, an alignment block for guiding the composite substrate 10 to an accurate placement position, a level adjustment apparatus for adjusting the level of the upper surface, and the like.

The water jet nozzle 120 may form a hole in the composite substrate 10 or cut the composite substrate 10 by receiving high-pressure water from the outside and ejecting the high-pressure water toward the composite substrate 10. An abrasive 121 may be supplied to the water jet nozzle 120, and the high-pressure water may include the abrasive 121. The abrasive 121 may include fine inorganic particles, for example, silica, alumina, zirconia, ceria, and the like, each having an average particle size of several nanometers to tens of micrometers.

The pressure of the high-pressure water supplied through the water jet nozzle 120 may be controlled by the jet pressure controller 130a. The jet pressure controller 130a may include a single computer apparatus, a semiconductor apparatus on which a computer program is executed, a memory apparatus on which a computer program is recorded, and the like.

The position and movement of the water jet nozzle 120 may be controlled by the motion controller 130b. The motion controller 130b may include a single computer apparatus, a semiconductor apparatus on which a computer program is executed, a memory apparatus on which a computer program is recorded, and the like.

In some embodiments, the jet pressure controller 130a and the motion controller 130b may be integrated into one computer program.

The water jet nozzle 120 may move along the upper surface of the support on the x-y plane parallel to the upper surface under the control of the motion controller 130b. In some embodiments, the water jet nozzle 120 may move in a z direction under the control of the motion controller 130b.

In some embodiments, the composite substrate cutting apparatus 100 may further include a pressurizing plate 150. The pressurizing plate 150 may apply a pressure to part of the composite substrate 10, and may be arranged to face the support 110 with the composite substrate 10 therebetween. In some cases, the composite substrate 10 may undergo warpage. In order to prevent the warpage from affecting cutting, during the cutting, the pressurizing plate 150 may press the composite substrate 10 to flatten the composite substrate 10.

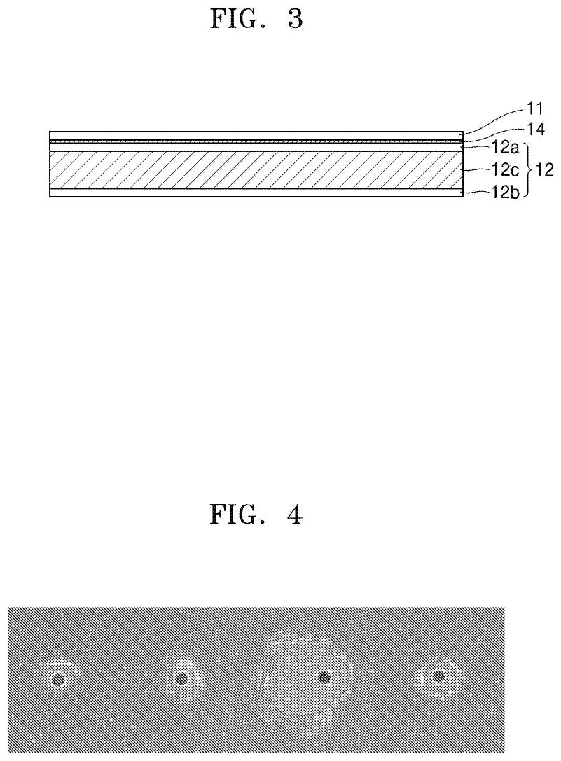

FIG. 3 is a schematic cross-sectional view of the composite substrate 10 cut by the composite substrate cutting apparatus 100.

Referring to FIG. 3, the composite substrate 10 may include a first layer 11 and a second layer 12 including a material different from the first layer 11. The first layer 11 and the second layer 12 may be bonded to each other by an adhesive layer 14.

In some embodiments, the first layer 11 may be a glass layer having a thickness of about 0.2 mm to about 1.4 mm. The first layer 11 may include, for example, aluminosilicate, alkali-aluminosilicate, borosilicate, alkali-borosilicate, aluminoborosilicate, alkali-aluminoborosilicate, soda lime, or other suitable glass materials. For example, commercialized products such as EAGLE XG®, Lotus™, Willow®, Iris™, Gorilla® glasses, and the like, which are manufactured by Corning, Inc. may be used as the first layer 11.

When the thickness of the first layer 11 is too small, handling thereof may be difficult due to insufficient mechanical strength. Also, when the thickness of the first layer 11 is too large, the weight of a product becomes excessive and the product may be aesthetically disadvantageous.

In some embodiments, the second layer 12 may include a first metal layer 12a having a thickness of about 0.2 mm to about 0.8 mm, a core substrate 12c having a thickness of about 1 mm to about 10 mm, and a second metal layer 12b having a thickness of about 0.2 mm to about 0.8 mm.

The first metal layer 12a and the second metal layer 12b each may independently include aluminum (Al), an aluminum alloy, a titanium (Ti), a titanium alloy, zinc (Zn), a zinc alloy, stainless steel, and the like. In some embodiments, the first metal layer 12a and the second metal layer 12b may each be an aluminum sheet or an aluminum alloy sheet.

The core substrate 12c may include a polymer layer having a non-woven structure. A polymer of the polymer layer may include polyethylene terephthalate, polystyrene, high-density polyethylene, low-density polyethylene, linear low-density polyethylene, polypropylene, polyurethane, and the like, but the disclosure is not limited thereto.

In some embodiments, the core substrate 12c may include a composite material of a metal oxide or semimetal oxide. The semimetal oxide may include silica. The metal oxide may include titania, alumina, zirconia, or ceria.

In some embodiments, the core substrate 12c may include wood or a material derived from wood. For example, the core substrate 12c may include articles made of wood, wood particles, and wood fibers such as a medium density fiberboard (MDF), a high pressure laminate (HPL), a low density fiberboard (LDF), a high density fiberboard (HDF), plywood, and the like.

In some embodiments, the core substrate 12c and the second metal layer 12b may be omitted.

High-pressure water ejected from the water jet nozzle 120 may pierce the first layer 11 and the second layer 12 at a time according to an ejection pressure. However, when the pressure of the high-pressure water is high enough to sequentially pierce the first layer 11 and the second layer 12, the first layer 11 may be seriously damaged.

FIG. 4 is an image of the first layer 11 damaged when the first layer 11 and the second layer 12 are pierced at a time by high-pressure water. As shown in FIG. 4, it is confirmed that the first layer 11 is damaged in all four holes.

The present inventors invented a method of forming a hole piercing the first layer 11 and the second layer 12, without undesirable damage to the first layer 11, and cutting the composite substrate 10 from the hole.

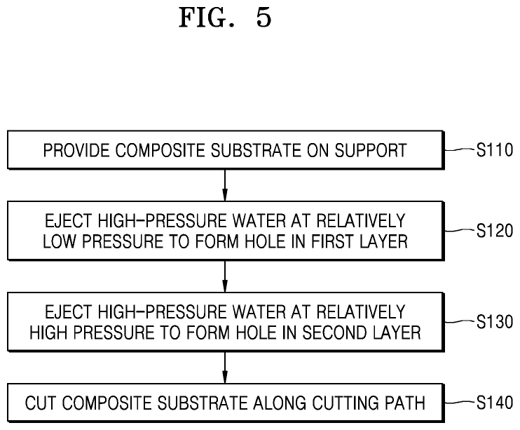

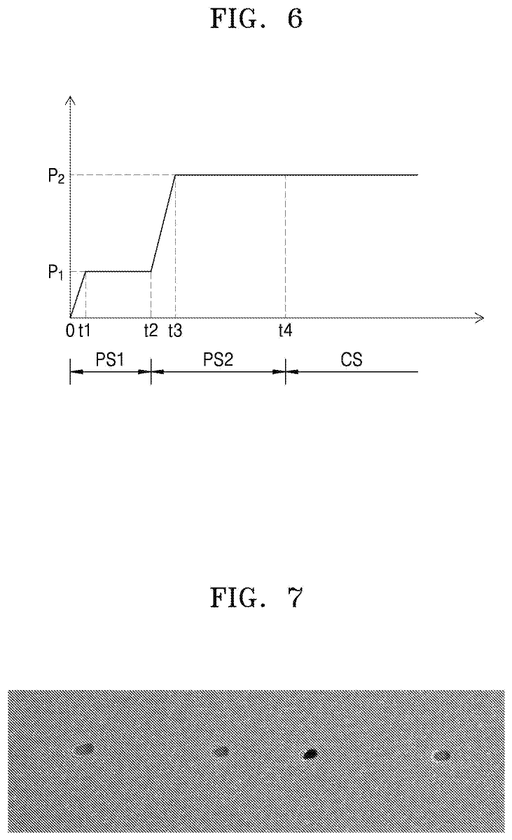

FIG. 5 is a flowchart of a method of cutting the composite substrate 10 according to an embodiment of the disclosure. FIG. 6 is a pressure profile of high-pressure water over time when the high-pressure water is ejected when the method of FIG. 5 is performed.

Referring to FIGS. 1, 5, and 6, the composite substrate 10 is provided on the support 110 of the composite substrate cutting apparatus 100 that is described above (S110). At this time, the composite substrate 10 may arranged such that the second layer 12 of the composite substrate 10 faces the support 110 and the first layer 11 faces the water jet nozzle 120. The first layer 11 may include a glass layer.

At this time, the position of the composite substrate 10 may be determined by an alignment block provided in the support 110, and may be fixed to the support 110 by using a clamp. In some embodiments, the composite substrate 10 may be pressed by the pressurizing plate 150 to be flatten.

Then, in order to form a hole in the first layer 11, high-pressure water may be ejected through the water jet nozzle 120 toward at a first pressure P₁ for a first duration (S120). A time of about t1 may be taken until the pressure of the high-pressure water reaches the first pressure P₁.

The first pressure P₁ may be about 5,000 psia to about 15,000 psia. In some embodiments, the first pressure P₁ may be within a range of about 6,000 psia to about 14,000 psia, about 7,000 psia to about 13,000 psia, about 7,500 psia to about 12,500 psia, about 8,000 psia to about 12,000 psia, about 8,500 psia to about 11,500 psia, about 9,000 psia to about 11,000 psia, or about 9,500 psia to about 10,500 psia. Furthermore, a second pressure P₂ may be within a range of the above values.

When the first pressure P₁ is too great, the first layer 11 may have undesirable damage, as shown in FIG. 4. Reversely, when the first pressure P₁ is too small, it may take too much time to form a hole in the first layer 11. For example, when the first pressure P₁ is appropriate, a hole may be formed in about 2.5 seconds to 4 seconds. However, when the first pressure P₁ is 4,500 psia, it may take over one minute to form a hole in the first layer 11 so that throughput may be remarkably lowered.

The first duration may be a time between a time point t2 and a time point t1, for example, about 1.5 seconds to about 5 seconds, about 2 seconds to about 4.5 seconds, or about 2.5 seconds to about 4 seconds.

The first pressure P₁ for ejecting the high-pressure water may have certain pulsation, but a change of the first pressure P₁ may be maintained within a range of about ±500 psia for at least the first duration.

A duration from when the high-pressure water starts to be ejected to a time point t2 when a hole is formed in the first layer 11 may be defined as a first piercing operation PS1.

Then, in order to form a hole in the second layer 12, high-pressure water may be ejected through the water jet nozzle 120 toward the second layer 12 via the hole formed in the first layer 11 at the second pressure P₂ during a second duration (S130). The second pressure P₂ may be a relatively high pressure compared to the first pressure P₁. About a time (t3−t2) may be taken for the pressure of the high-pressure water to reach the second pressure P₂ from the first pressure P₁.

The second pressure P₂ may be about 45,000 psia to about 90,000 psia. In some embodiments, the second pressure P₂ may be within a range of about 45,000 psia to about 90,000 psia, about 46,000 psia to about 85,000 psia, about 47,000 psia to about 80,000 psia, about 48,000 psia to about 75,000 psia, about 49,000 psia to about 70,000 psia, about 50,000 psia to about 65,000 psia, or about 45,000 psia to about 55,000 psia. Furthermore, the second pressure P₂ may be in a range of the above values.

When the second pressure P₂ is too great, the life of the composite substrate cutting apparatus 100 may be shortened. When the second pressure P₂ is too small, it may take much time to form a hole in the second layer 12.

The second duration may be a time between a time point t3 and a time point t4, for example, about 1 second to about 5 seconds, about 1.5 seconds to about 4.5 seconds, or about 2 seconds to about 4 seconds.

The second pressure P₂ for ejecting the high-pressure water may have certain pulsation, but a change of the first pressure P₂ may be maintained within a range of about ±2,000 psia for at least the second duration.

A duration from the time point t2 when the hole is formed in the first layer 11 to the time point t4 when a hole is formed in the second layer 12 may be defined as a second piercing operation PS2.

The second piercing operation PS2 may be in succession to the first piercing operation PS1.

FIG. 7 is an image of holes formed according to the pressure profile of FIG. 6. As shown in FIG. 7, it may be seen that all holes are normally formed without damaging the first layer 11.

A cutting operation CS may be performed subsequent to the second piercing operation PS2 (S140).

The cutting operation CS may be performed by moving the water jet nozzle 120 along a cutting path. The cutting path may be an arbitrary path, for example, a path indicated by a dotted line on the composite substrate 10 of FIG. 2. The cutting path may not meet an edge of the composite substrate 10.

In the cutting operation CS, the pressure of high-pressure water ejected through the water jet nozzle 120 may be maintained as a cutting pressure. The cutting pressure may be about 45,000 psia to about 90,000 psia. In some embodiments, the cutting pressure may be within a range of about 45,000 psia to about 90,000 psia, about 46,000 psia to about 85,000 psia, about 47,000 psia to about 80,000 psia, about 48,000 psia to about 75,000 psia, about 49,000 psia to about 70,000 psia, about 50,000 psia to about 65,000 psia, or about 45,000 psia to about 55,000 psia. Furthermore, the cutting pressure may be within a range of the above values.

In some embodiments, the cutting pressure may be substantially the same as the second pressure P₂. In this case, the pressure of high-pressure water may be maintained constant in the cutting operation CS and the second piercing operation PS2.

The holes piercing the first layer 11 and the second layer 12 are respectively formed in the first piercing operation PS1 and the second piercing operation PS2, and in the cutting operation CS, starting from the holes, the high-pressure water gradually grinds the first layer 11 and the second layer 12 in a lateral direction. It may be understood that, even when the cutting pressure is maintained to be a relatively high pressure, for example, the second pressure P₂, no undesirable damage is generated in the first layer 11. However, the disclosure is not limited to a specific theory or principle.

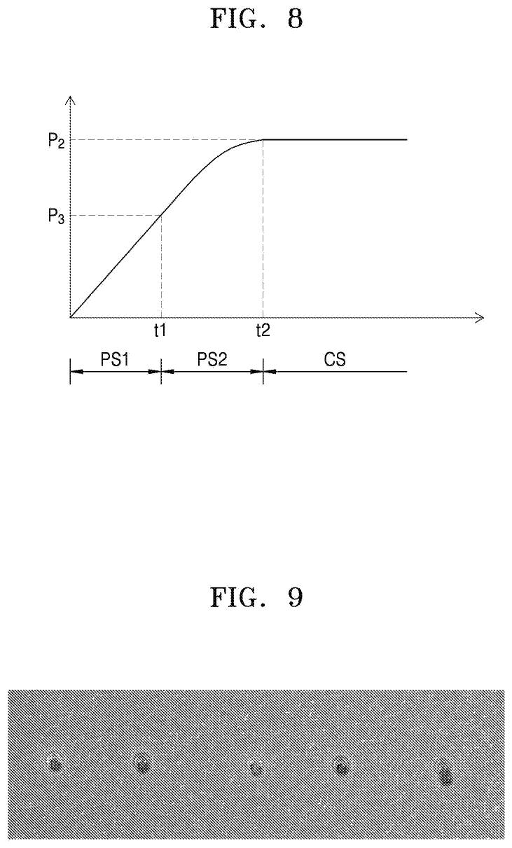

FIG. 8 is a pressure profile of high-pressure water over time when the high-pressure water is ejected in a method of cutting the composite substrate 10 according to another embodiment of the disclosure.

Referring to FIGS. 1, 3, and 8, the first piercing operation PS1 of forming a hole in the first layer 11 and the second piercing operation PS2 of forming a hole in the second layer 12 may be successively performed. In particular, the ejection pressure of the high-pressure water may increase substantially constantly while the first piercing operation PS1 and the second piercing operation PS2 are performed. The first piercing operation PS1 may be defined as a duration from when the pressure of high-pressure water starts to increase to a time point t1 when a hole is formed in the first layer 11. Furthermore, the second piercing operation PS2 may be defined as a duration from the time point t1 when a hole is formed in the first layer 11 to a time point t2 when a hole is formed in the second layer 12.

A duration from the time point when the ejection pressure of the high-pressure water starts to increase to the time point t2 may be about 3 seconds to about 10 seconds, about 3.5 seconds to about 9 seconds, about 4 seconds to about 8.5 seconds, about 4.5 seconds to about 8 seconds, or about 4.8 seconds to about 7.5 seconds.

In some embodiments, the ejection pressure of the high-pressure water may be increased to the second pressure P₂. As the numerical range of the second pressure P₂ is described above, a detailed description thereof is omitted.

An increase rate of the ejection pressure of the high-pressure water may be about 5,000 psia/s to about 13,000 psia/s. In some embodiments, the increase rate of the ejection pressure of the high-pressure water may be within a range of about 5,500 psia/s to about 12,700 psia/s, about 6,000 psia/s to about 12,500 psia/s, about 6,500 psia/s to about 12,300 psia/s, about 7,000 psia/s to about 12,000 psia/s, about 7,500 psia/s to about 11,700 psia/s, or about 8,000 psia/s to about 11,500 psia/s. Furthermore, the increase rate of the ejection pressure may be within a range of the above values.

The cutting pressure in the cutting operation CS may be substantially the same as the second pressure P₂.

A third pressure P₃ that is the pressure of high-pressure water at the time point t1 when a hole is formed in the first layer 11 may be about 15,000 psia to about 33,000 psia. In some embodiments, the third pressure P₃ may be within a range of about 16,000 psia to about 32,000 psia, about 18,000 psia to about 31,000 psia, about 20,000 psia to about 30,000 psia, about 22,000 psia to about 29,000 psia, or about 24,000 psia to about 28,000 psia. Furthermore, the third pressure P₃ may be within a range of the above values.

FIG. 9 is an image of holes formed according to the pressure profile of FIG. 8. As shown in FIG. 9, it may be seen that all holes are normally formed without damaging the first layer 11.

As described with reference to FIG. 5, the cutting operation CS may be performed in succession to the second piercing operation PS2. As the cutting operation CS is substantially the same as the cutting operation CS described with reference to FIG. 6, a detailed description thereof is omitted.

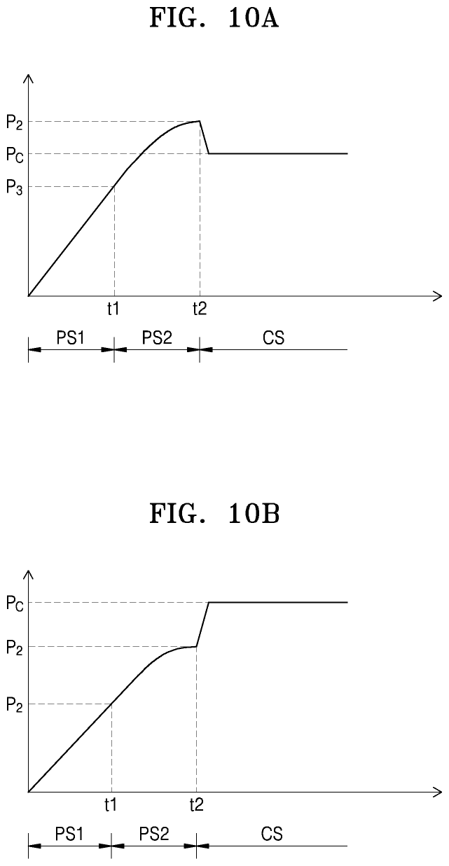

FIGS. 10A and 10B are pressure profiles of high-pressure water over time when the high-pressure water is ejected in methods of cutting a composite substrate according to embodiments of the disclosure.

Referring to FIG. 10A, the pressure profile of high-pressure water is the same as that of FIG. 8, except that a cutting pressure Pc in the cutting operation CS is less than the second pressure P₂. Accordingly, in the following description, redundant descriptions are omitted and such a difference is mainly described.

After a hole is formed in the second layer 12, the cutting pressure Pc may be adjusted to be less than the second pressure P₂. The cutting pressure Pc may be, for example, about 30,000 psia to about 50,000 psia. In some embodiments, the cutting pressure Pc may be within a range of about 30,000 psia to about 49,000 psia, about 32,000 psia to about 48,000 psia, about 34,000 psia to about 47,000 psia, about 36,000 psia to about 46,000 psia, or about 38,000 psia to about 45,000 psia. Furthermore, the cutting pressure Pc may be within a range of the above values.

Referring to FIG. 10B, the pressure profile of high-pressure water is the same as that of FIG. 8, except that a cutting pressure Pc in the cutting operation CS is greater than the second pressure P₂. Accordingly, in the following description, redundant descriptions are omitted and such a difference is mainly described.

After a hole is formed in the second layer 12, the cutting pressure Pc may be adjusted to be higher than the second pressure P₂. The cutting pressure Pc may be, for example, about 45,000 psia to about 60,000 psia. In some embodiments, the cutting pressure Pc may be within a range of about 46,000 psia to about 59,000 psia, about 47,000 psia to about 58,000 psia, about 48,000 psia to about 57,000 psia, about 49,000 psia to about 56,000 psia, or about 50,000 psia to about 55,000 psia. Furthermore, the cutting pressure Pc may be within a range of the above values.

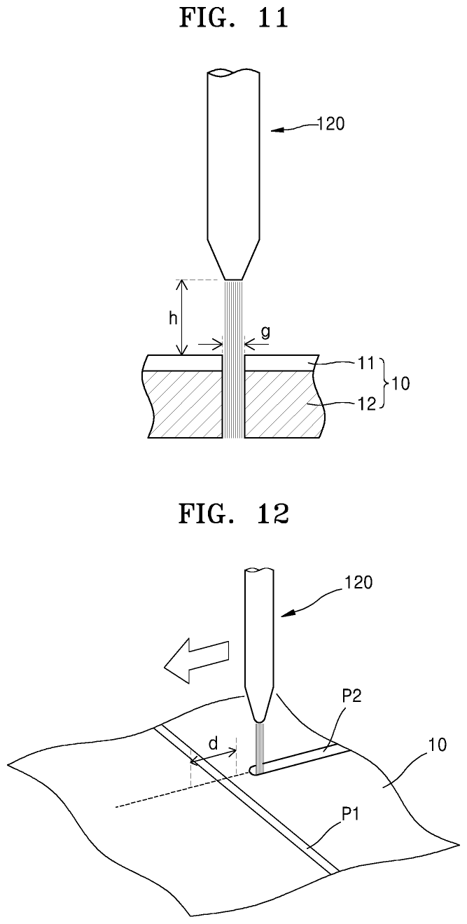

FIG. 11 is a schematic view of a relative arrangement of the composite substrate 10 to be cut and the water jet nozzle 120.

Referring to FIG. 11, when the water jet nozzle 120 ejects high-pressure water, a distance between an upper surface of the composite substrate 10 and a tip of the water jet nozzle 120 may be adjusted to be about 3 mm to about 20 mm. In some embodiments, the distance may be adjusted to be in a range of about 5 mm to about 19 mm, about 7 mm to about 18 mm, about 9 mm to about 17 mm, or about 10 mm to about 16 mm. In some embodiments, the distance between the upper surface of the composite substrate 10 and the tip of the water jet nozzle 120 may be the same in the piercing operation and the cutting operation.

When the distance is too great, the diameter and/or a cutting width of the hole formed in the composite substrate 10 may be too large. When the distance is too small, the diameter and/or the cutting width of the hole formed in the composite substrate 10 may be irregular. The distance between the upper surface of the composite substrate 10 and the tip of the water jet nozzle 120 may be adjusted by the motion controller 130b of FIG. 1.

An angle of the water jet nozzle 120 with respect to the upper surface of the composite substrate 10 may be about 60° to about 90°. In some embodiments, the angle may be about 80° to about 90° or about 85° to about 90°. In some embodiments, the angle of the water jet nozzle 120 with respect to the upper surface of the composite substrate 10 may be adjusted by the motion controller 130b.

The diameter g (or the cutting width) of the hole formed in the first layer 11 by the high-pressure water ejected from the water jet nozzle 120 may be about 0.6 mm to about 1.5 mm. In some embodiments, the diameter g (or the cutting width) may be within a range of about 0.65 mm to about 1.45 mm, about 0.7 mm to about 1.4 mm, about 0.75 mm to about 1.35 mm, about 0.8 mm to about 1.3 mm, or about 0.85 mm to about 1.25 mm. Furthermore, the diameter g (or the cutting width) may be within a range of the above values.

FIG. 12 is a schematic view of a method of cutting the composite substrate 10 according to an embodiment of the disclosure.

Referring to FIG. 12, the composite substrate 10 is already cut along a first path P₁ in a first direction, and the composite substrate 10 is being cut along a second path P₂ in a second direction as the water jet nozzle 120 ejects high-pressure water. The first direction and the second direction cross each other.

In this case, while the composite substrate 10 is cut along the second path P₂, the cutting pressure of high-pressure water may be adjusted when the water jet nozzle 120 passes across the first path P₁ along which the composite substrate 10 was already cut. In other words, while the water jet nozzle 120 cuts the composite substrate 10 along the second path P₂, the cutting pressure of the water jet nozzle 120 may be adjusted to be within a range of about 45,000 psia to about 55,000 psia right before and after passing across the first path P₁ along which the composite substrate 10 was already cut.

When the water jet nozzle 120 passes across the first path P₁ along which the composite substrate 10 was cut while the composite substrate 10 is being cut along the second path P₂, if the cutting pressure is maintained to be high, for example, above 55,000 psia, it may be seen that the first layer 11 is damaged at an intersection between the paths P₁ and P₂. In this case, when the cutting pressure of high-pressure water is adjusted to be within a range of about 45,000 psia to about 55,000 psia with respect to the distance d right before and after passing across the first path P₁ along which the composite substrate 10 was already cut, a clean cutting plane without damaging the first layer 11 may be obtained at the intersection.

In the composite substrate cutting apparatus and the method of cutting a composite substrate according to embodiments of the disclosure, a composite substrate may be cut without undesirable damage to the first layer.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An apparatus for cutting a composite substrate, the apparatus comprising:
a support configured to support a composite substrate that comprises a first layer and a second layer including a material different from the first layer;
a water jet nozzle configured to eject high-pressure water to cut the composite substrate and move along an upper surface of the support;
a jet pressure controller configured to control a pressure of the high-pressure water ejected from the water jet nozzle; and
a motion controller configured to control a movement of the water jet nozzle,
wherein the jet pressure controller is configured to perform:
a first piercing operation of ejecting the high-pressure water at a relatively low pressure to form a hole in the first layer; and
a second piercing operation of ejecting the high-pressure water at a relatively high pressure to form a hole in the second layer through the hole formed in the first layer after the first piercing operation.

2. The apparatus of claim 1, wherein the motion controller is configured to move the water jet nozzle along a cutting path after the hole is formed in the second layer, and
the jet pressure controller is further configured to maintain an ejection pressure of the high-pressure water at a cutting pressure of about 45,000 psia to about 90,000 psia when the water jet nozzle moves along the cutting path.

3. The apparatus of claim 2, wherein, when the water jet nozzle performs cutting across the cutting path along which the composite substrate was already cut, the jet pressure controller is configured to limit the cutting pressure to be between about 45,000 psia and about 55,000 psia.

4. The apparatus of claim 1, wherein the first piercing operation is an operation in which, for a first duration, the pressure of the high-pressure water is maintained at a first pressure of about 5,000 psia to about 15,000 psia, and
the second piercing operation is an operation in which, for a second duration, the pressure of the high-pressure water is maintained at a second pressure of about 45,000 psia to about 90,000 psia.

5. The apparatus of claim 4, wherein, in the first piercing operation, a change in the first pressure is maintained within a range of ±500 psia for a time of 1.5 seconds or more and 5 seconds or less, and
in the second piercing operation, a change in the second pressure is maintained within a range of ±2000 psia for a time of 1 second or more and 5 seconds or less.

6. The apparatus of claim 2, wherein the first layer is a glass layer having a thickness of about 0.2 mm to about 1.4 mm.

7. The apparatus of claim 2, wherein the second layer comprises:
a first metal layer having a thickness of about 0.2 mm to about 0.8 mm;
a core substrate having a thickness of about 1 mm to about 10 mm; and
a second metal layer having a thickness of about 0.2 mm to about 0.8 mm.

8. The apparatus of claim 1, wherein the jet pressure controller is configured to control the first piercing operation and the second piercing operation to be successively performed and substantially uniformly increase an ejection pressure of the high-pressure water to reach a cutting pressure when the second piercing operation is finished.

9. The apparatus of claim 1, wherein the motion controller is configured to control a position of the water jet nozzle such that a distance between a tip of the water jet nozzle and the composite substrate is about 3 mm to about 20 mm.

10. The apparatus of claim 1, further comprising a pressurizing plate configured to apply a pressure to a part of the composite substrate to flatten the composite substrate, the pressurizing plate being provided to face the support with the composite substrate therebetween.

11. A method of cutting a composite substrate, the method comprising:
providing the composite substrate on a support, the composite substrate comprising a first layer and a second layer comprising a material different from the first layer;
a first piercing operation of ejecting high-pressure water at a relatively low pressure through a water jet nozzle to form a hole in the first layer;
a second piercing operation of ejecting the high-pressure water at a relatively high pressure through the water jet nozzle to form a hole in the second layer through the hole formed in the first layer, after the first piercing operation; and
a cutting operation of moving the water jet nozzle along a cutting path while the water jet nozzle ejects the high-pressure water through the water jet nozzle at a cutting pressure, after the second piercing operation.

12. The method of claim 11, wherein the first piercing operation is an operation in which, for a first duration, the pressure of the high-pressure water is maintained at a first pressure of about 5,000 psia to about 15,000 psia, and
the second piercing operation is an operation in which, for a second duration, the pressure of the high-pressure water is maintained at a second pressure of about 45,000 psia to about 90,000 psia.

13. The method of claim 12, wherein the second pressure is substantially the same as the cutting pressure.

14. The method of claim 11, wherein the first piercing operation and the second piercing operation are successively performed, and
an ejection pressure of the high-pressure water is substantially uniformly increased from a start of the first piercing operation to reach the cutting pressure at a completion of the second piercing operation.

15. The method of claim 11, wherein the cutting pressure is between about 45,000 psia and about 90,000 psia.

16. The method of claim 15, wherein, in the cutting operation, when the water jet nozzle performs cutting across a cutting path along which the composite substrate was already cut, the cutting pressure is limited to be between about 45,000 psia and about 55,000 psia.
